(19) United States
(12) Patent Application Publication
(10) Pub. No.: US 2007/0212670 A1
(43) Pub. Date: Sep. 13, 2007

(54) Method for Teaching a Language

(76) Inventors: Robert James Paech, Greenwood Village, CO (US); Joshua Randolph Paech, Queensland (AU)

Correspondence Address: DOWNS RACHLIN MARTIN PLLC, 199 MAIN STREET, P O BOX 190, BURLINGTON, VT, 05402-0190, US

(21) Appl. No.: 10/593,686

(22) PCT Filed: Mar. 18, 2005
(86) PCT No.: PCT/AU05/00377

§ 371 Date: May 23, 2007

(30) Foreign Application Priority Data
Mar. 19, 2004 (AU) 2004901482

(51) Int. Cl. G09B 19/04

(52) U.S. Cl. 434/185

(57) ABSTRACT

A method of encoding words for language teaching comprising the steps of identifying a plurality of different vowel sounds, representing each different vowel sound by a first indicia and a second indicia, storing the different first and second indicias for each vowel sound, identifying a plurality of different consonant sounds, representing each consonant sound by a third indicia and a selection of consonant sounds by a (Insert B) fourth indicia, storing the third and fourth indicia for each consonant sound, identifying a plurality of different silent letters occurring in words, representing each silent letter by a fifth indicia and storing the fifth indicias for each silent letter whereby a word is represented by a combination of the first to fifth indicias.

### FIELD OF THE INVENTION

The present invention relates to language teaching.

For convenience, the present invention will be described primarily with regard to teaching the English language. However, it is to be understood that the invention is equally applicable to teaching other languages.

A typical way of teaching a language such as English involves a classroom situation with a teacher demonstrating the pronunciation of various combinations of letters and words and with students repeating these sounds as a group. More recently it is possible to supplement this technique by using computer-based language teaching aids. However, such aids tend to have limited value as they have a piecemeal structure which is difficult to navigate.

### BRIEF DESCRIPTION OF THE PRIOR ART

Some existing teaching aids utilise computer-aided techniques using speech recognition software. Typically such computer-based teaching methods involve a student repeating a word which is pronounced by a computer tutor, such as in U.S. Pat. No. 41,210,512. Other teaching methods such as that disclosed in PCT application no. WO 00/60560 disclose a method of converting plain English text to a number of levels of enriched text, each of which incorporates progressively more clues to the pronunciation of the words of the text. The clues include colours, shapes, graphs and markers which tend to complicate rather than simplify the learning process.

### SUMMARY OF THE INVENTION

The present invention is aimed at providing an alternative method of teaching a language. In a particular form the invention is directed at a method of encoding words which enhances a student's ability to learn how to pronounce different words.

According to a first aspect of the present invention there is provided a method of encoding words for language teaching comprising the steps of identifying a plurality of different vowel sounds, representing each different vowel sound by a first indicia and a second indicia, storing the different first and second indicias for each vowel sound, identifying a plurality of different consonant sounds, representing each consonant sound by a third indicia and a selection of consonant sounds by a fourth indicia, storing the third and fourth indicia for each consonant sound, identifying a plurality of different silent letters occurring in words, representing each silent letter by a fifth indicia and storing the fifth indicias for each silent letter whereby a word is represented by a combination of the first to fifth indicia.

According to another aspect of the present invention there is provided a method of displaying words for language teaching, comprising the steps of identifying a word, encoding the word into a plurality of indicia components and displaying the encoded word comprising indicia components, wherein the plurality of indicia comprise a first and second indicia representing different vowel sounds, third indicia representing different consonant sounds, fourth indicia representing a selection of consonant sounds and fifth indicia representing different silent letters occurring in words.

According to a further aspect of the present invention there is provided a system for teaching a language comprising a database which stores a plurality of different vowel sounds, with each vowel sound represented by a first indicia and a second indicia, a plurality of different consonant sounds, with each consonant sound represented by a third indicia and a selection of consonant sounds by a fourth indicia, a plurality of different silent letters occurring in words, with each silent letter represented by a fifth indicia, and a plurality of different words, a conversion means which converts each word into a converted form comprising the indicia and a display means which displays a word in converted form, and wherein the conversion means is adapted to convert a word input into the system and utilise the display means to display the word in converted form.

It is preferred that the methods and system involve storing all different vowel sounds and all different consonant sounds.

Preferably the selection comprises consonants, diagraphs or consonant blends or other consonants having a particular characteristic.

Preferably, the method includes identifying a plurality of different consonant diagraph sounds, representing each consonant diagraph sound by a sixth indicia and storing the sixth indicia for each consonant diagraph sound.

An indicia may include any symbol(s), number(s), notation(s), letter(s), colour(s), font(s), mark(s), representation(s), zone(s) or any other sign.

The method may include creating a database comprising the different indicia.

According to one embodiment the method includes creating a dictionary database which stores the meaning of each word.

According to another embodiment the dictionary database stores the prefix, roote and suffix of words.

According to a further embodiment the method involves displaying the prefix/roote and suffix of each word.

It is preferred that words displayed with a prefix, roote and suffix are shown in coded form represented by the applicable indicia.

According to another embodiment the strength of each sound is represented by a seventh indicia.

The seventh indicia may be a different level of brightness or boldness of colour for the letter or letters of the particular sound.

The database may store a plurality of words with each word represented by a composite of indicia.

The database preferably stores words divided into multiple syllables.

It is preferred that words are divided into constituent components of vowel sounds, consonant sounds and silent letters.

Words divided into constituent sounds are preferably then converted into corresponding indicia representing each of those sounds.

It is preferred that words are stored once converted into constituent indicia components.

Preferably, the database stores words with multiple syllables.

It is preferred that each word is stored with links to constituent indicia components which represent the word when it is displayed in converted form.

Preferably, the second indicia are substantially the same for each vowel sound.

According to one example, a second indicia comprises a colour which is substantially the same for each vowel sound.

Preferably, the fourth indicia are substantially the same for each consonant sound.

As an example, each consonant sound has substantially the same colour.

The colour of each second indicia is preferably different to the colour of each fourth indicia.

The fifth indicia may be substantially the same for each silent letter.

As an example the fifth indicia may be substantially the same colour.

One or more the indicia may have different levels of any one or more of, brightness, colour, contrast, boldness to represent strength of associated vowel or consonant sound.

Preferably, the vowel sounds include one or more vowels.

Preferably, the consonant sounds include one or more consonants.

It is preferred that the first indicia is different for each vowel sound.

According to one example, a first indicia is a number, with different numbers representing different vowel sounds.

According to one embodiment, only consonant sounds which have more than one pronunciation have a third indicia.

As an example, a third indicia may be a superscript symbol or the absence of such a symbol.

Preferably, the first indicia comprises a superscript symbol.

According to a further embodiment of the present invention the third indicia comprises a sign representing a consonant diagraph.

The first and/or third indicia may be in the form of superscripts or subscripts.

The method of displaying words may include displaying the first indicia above the vowel sounds.

The method of displaying may include displaying a word as a combination of vowel sounds, consonant sounds and silent letters.

According to one embodiment, multiple syllable words are displayed with a dividing means between syllables.

The dividing means may be punctuation marks such as a hyphen or dot.

According to one embodiment of the invention the methods and system include displaying a matrix/grid with vowel sounds along one axis and consonant sounds along another.

It is preferred that the axis form columns and rows.

The grid may comprise grid spaces or squares or equivalent marks representing a combination of one vowel sound and one consonant sound along respective axes.

Preferably, the method includes displaying a composite of any vowel sound and consonant sound once a grid is selected corresponding to an intersecting row and column of one vowel sound and one consonant sound.

Alternatively, vowel sounds and consonant sounds are represented in separate groups with a link between each vowel sound and consonant sound which is able to be blended together.

The methods may include displaying visually and/or aurally words or blended sounds.

According to one embodiment the method includes a speaking means which pronounces different sounds when blended together.

According to another embodiment of the invention the method includes displaying rows/columns of consonants and consonant diagraphs.

The methods and system may include searching for words including at least one of the indicia, vowel sounds, consonants, consonant diagraphs, silent letters.

The step of searching may include searching for words having a combination of two or more of (indicia one to six, vowel sounds, consonant sounds, consonant diagraphs, silent letters, two syllables, three syllables, greater than three syllables, predetermined word lengths, words).

The step of searching may be based on the position of stressed syllables.

The step of searching may include searching through converted words stored in a database to a identify any search criteria.

It is preferred that each word which is stored in the database is stored with links to files with data relating to features of the word including:

number of indicia, types of indicia, location of indicia, number of syllables, word length, different sounds, etc.

The methods and systems may include providing an interrogation means which is configured to receive one or more of the items: indicia one to six, vowel sounds, consonant sounds, silent letters, number of letters in a word, number of syllables in a word or other data relating to a word.

Preferably, the step of searching is followed by the step of displaying the search results with words in converted form arranged in a predetermined order such as alphabetically.

It is to be understood that reference to marks, squares, spaces include reference to symbols, labels, signs, spaces, representations, indicia, indications, points, areas, zones or any other ways of representing.

It is also to be understood that reference to arrays or grids include any equivalent representations in which different types of sounds are able to be combined and represented by a single mark or equivalent.

It is preferred that the methods include displaying an array showing consonant blends such as, for example, a row of some consonants and a column of other consonants. The array may comprise a plurality of marks or squares with squares highlighted if consonant blends are permissible.

Preferably, marks can be activated to produce an indication of the consonant blend sound.

Preferably, displaying an array or grid includes an array of initial consonant blends or final consonant blends.

A mark may be activated by controlling a cursor for example, by clicking on a mouse.

According to one embodiment the methods include displaying a plurality of different grids each with different blends of sounds.

As an example, a column may list one type of sound, for example a vowel sound, consonant sound, consonant diagraph sound and a row may list another of one of the vowel sounds, consonant sounds, consonant diagraphs.

The intersection of a row/column may be represented by a mark with each mark representing a different blend of sounds.

The method may include a plurality of teaching lessons.

Preferably one teaching lesson is associated with one array/grid of blended sounds.

One teaching lesson may highlight examples of blended sounds on the grid.

The step of highlighting may include representing the intersection of a row and column forming a blended sound differently from other grid zones.

The step of highlighting may include providing intersection marks between blended indicia/sounds.

Intersection marks may comprise lines extending from row and column sounds.

It is to be understood that, if any prior art publication is referred to herein, such reference does not constitute an admission that the publication forms a part of the common general knowledge in the art, in Australia or in any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that the aforementioned preferable statements refer to important features of different embodiments of the invention.

### BRIEF DESCRIPTION OF THE DRAWINGS

Preferred embodiments of the present invention will now be described by way of example only with reference to the accompanying drawings, in which:

FIG. 1a shows an example of a word converted to a coded form in accordance with a preferred embodiment of the invention;

FIG. 1b shows a representation of different vowel sounds in accordance with the present invention;

FIG. 2 shows a representation of different consonant sounds in accordance with a preferred embodiment of the present invention;

FIG. 3 shows examples of different silent letters in accordance with the preferred embodiment of the invention;

FIG. 4 shows a display of consonant sounds and vowel sounds in accordance with the preferred embodiment of the invention;

FIG. 5 shows a grid system for displaying consonant blends in accordance with the preferred embodiment of the invention;

FIG. 6 shows another embodiment of a grid structure for consonant blends in accordance with the present invention;

FIG. 7 shows a further embodiment of a grid structure for blending sounds in accordance with the present invention;

FIG. 8 shows a search system in accordance with the preferred embodiment of the invention;

FIG. 9 shows an example of a sentence with words converted to a coded form in accordance with the preferred embodiment of the invention; and

FIG. 10 shows an example of an indexing method for storing words in a library database in accordance with the preferred embodiment of the invention.

### DETAILED DESCRIPTION OF THE PREFERRED EMBODIMENT

The invention is preferably implemented using computer software to control operation of a data processor such as a personal computer. It should be understood however, that the invention may be used as a teaching aid independently of computer software. For example, the invention may be implemented in a book form which may incorporate cards with specific information on them.

To assist with an understanding of the invention, the preferred embodiment will be described with reference to an English language implementation of the invention with particular emphasis on a computer software implementation of the invention.

In accordance with the preferred embodiment, any word in the English language is converted to a form which enables a student learning English to easily understand how each word is pronounced. Furthermore, the converted or encoded form of each English word permits a logical and structural approach to teaching and learning English to be achieved.

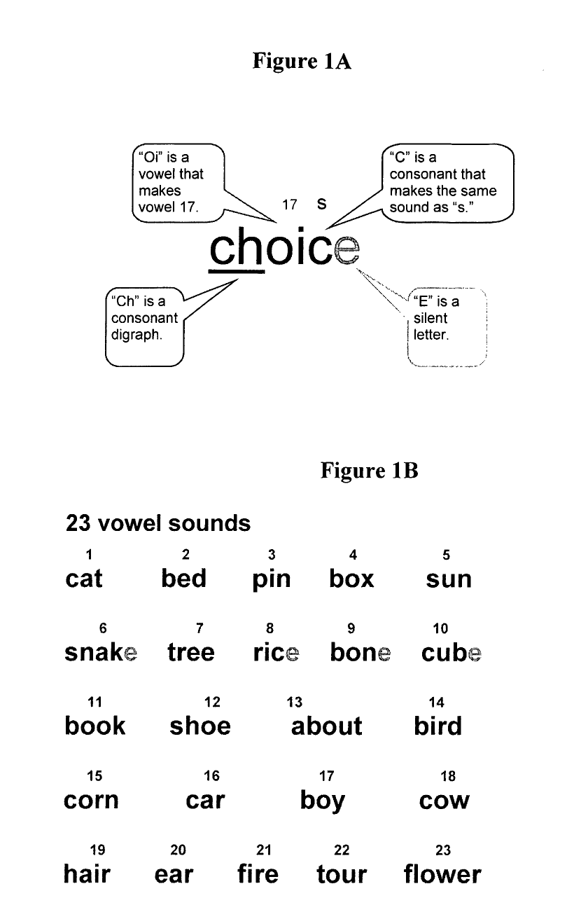

As shown in FIG. 1b, in accordance with the preferred embodiment of the invention, each English vowel sound is represented by a number from 1 to 23. This covers all the possible vowel sounds in the English language. Thus, as an example the word “cat” is represented with a number 1 above the letter “a”. This signifies that the vowel sound 1 has the same pronunciation as the letter “a” when used in the word “cat”.

In a similar fashion, in the word “snake” a numeral 6 is located above the letter “a”. This signifies that the vowel sound 6 is pronounced as “a” in “snake”. This contrasts with the vowel sound 13 for pronouncing “a” in the word “about”.

Vowel sounds which include a combination of vowels are also represented by a number such as the number 23 which represents “ow” as pronounced in the word “flower”, or the vowel sound 22 which designates the “ou” sound in the word “tour”.

By breaking the number of vowel sounds into a minimum of 23, it is possible to simplify teaching vowel sounds occurring in words.

As an example, the vowel sound 23 which represents the “ow” sound occurring in the word “flower” also represents the “ou” in the word “grout”. This simplifies learning of the pronunciation of English words because the student only needs to concentrate on the type of vowel sound as represented by the coded number, rather than how the vowel sound is spelt. Over a period of time a language student would become more familiar with the different ways of spelling the same vowel sound occurring in different words.

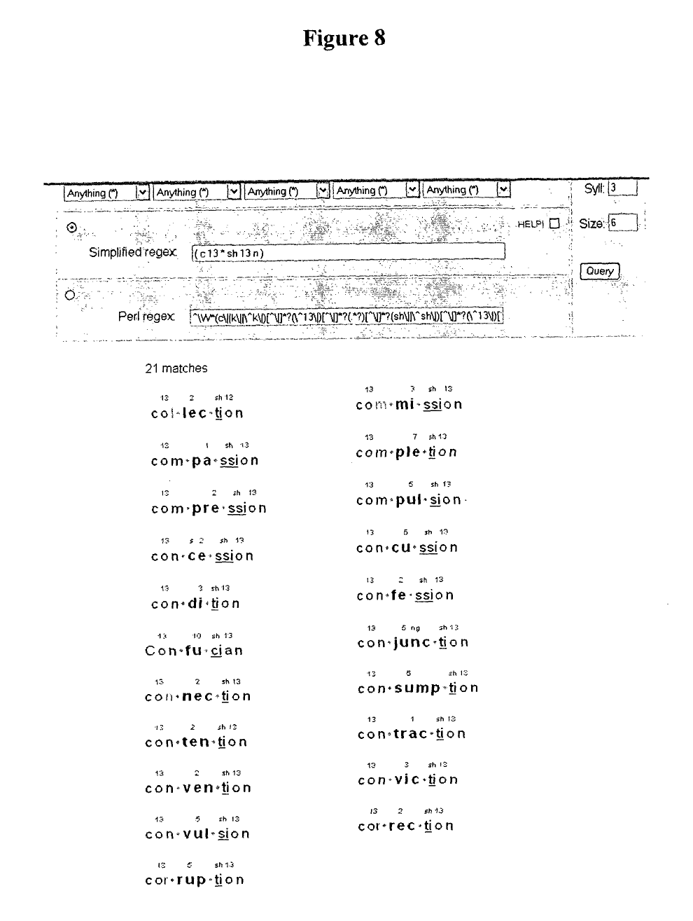

In addition to the above, each vowel sound is represented by a colour which in FIG. 1 is red. This clarifies which letters are to be pronounced according to the coded representation of the vowel sound. Thus, in the word “about” the number 13 is provided as a superscript above the letter “a” which is coloured red. The rest of the word, ie. “bout” is differently coloured for the purposed of this example. This makes it clear that the vowel sound is associated with the letter “a” and not the letters “ou” for example. This makes it easier for a student to identify the vowel sound and the letter or letters which are to be pronounced in accordance with the vowel sound. Furthermore, although it is preferred that the vowel sound is represented as a number in superscript form above the particular letters concerned, in a word with a single vowel sound being exemplified, the location of the vowel sound superscript is not as important as it is instantly recognisable as being associated with the letters in red. Of course in a word with a number of different vowel sounds, this approach would not be ideal. However, it is also possible to represent the different vowel sound numbers in a colour which is the same as the letters with which they are associated. Thus, in FIG. 8 the word “collection” includes vowel sounds 13 and 2. By placing the number 13 above the letter “o” it is clear that the “o” in collection is pronounced as vowel sound 13 and the letter “e” with the superscript 2 above it is pronounced as vowel sound 2. Both the letter “o” and the letter “e” may be red like the superscripts 13 and 2. However, according to another embodiment the numeral 13 and the letter “o” may be represented in one colour and the number 2 and letter “e” by another colour.

Another advantage of representing vowels sounds in the manner outlined above is that students can see a word and instantly know how the vowel sound should be pronounced.

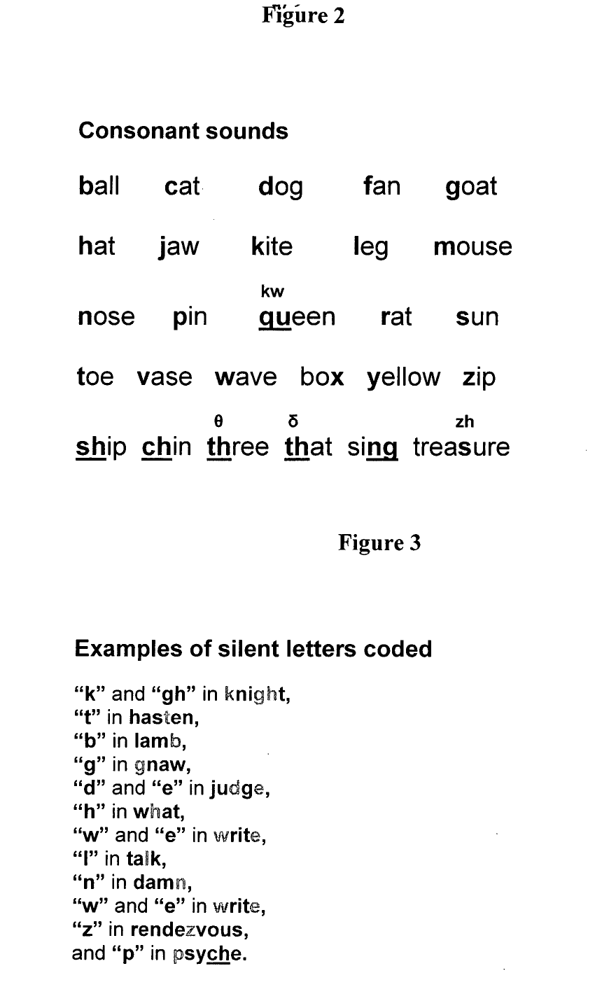

FIG. 2 shows a list of the consonant sounds as part of a word in a similar fashion to the list of vowel sounds. Each consonant sound is represented by a blue colour with the rest of word being in black. Consonant sounds which are the result of a combination of at least two letters are highlighted by either a superscript symbol, such as Θ for the consonant sound “th” or by the phonetically equivalent letters for that consonant sound. Thus in the word “treasure” the letter “s” is highlighted in blue with the letters “zh” in superscript form above it.

If the consonant sound is formed by a combination of letters (consonant diagraphs), they are also highlighted by being underlined. Thus the consonant sound “qu” in “queen” is shown underlined and also has a superscript “kw” indicating how the “qu” sound is pronounced.

In a word where a consonant is not highlighted by a symbol or with a superscript or underlining, it is understood that the consonant is pronounced in accordance with the consonant sounds as shown in the list in FIG. 2. Thus, as shown, there are 27 different consonant sounds which are represented according to the preferred embodiment.

Finally, there are letters in the English language which are not pronounced or in other words are silent letters. Examples of these are shown in FIG. 3. In each word where a silent letter or combination of letters occurs, it is represented by a colour different to that adopted for a vowel sound or a consonant sound. It may also be represented in other forms such as in a particularly light or faint colour. Thus, in the word “knight”, the letter “k” and the letters “g” and “h” are each silent. They are therefore represented in a light grey colour whereas the consonants “n” and “t” are represented in blue and the vowel “I” in red. In this way and as exemplified further in FIG. 1A it is possible to convert any word into a coded form utilising the coding system exemplified with reference to FIG. 1B, FIG. 2 and FIG. 3.

In FIG. 1A the word “choice” is able to be converted and represented with the consonant sound “ch” in blue and underlined, the letters “oi” in red with a superscript number 17, the letter “c” in blue with the superscript S, and the letter “e” in grey as a silent letter. From this coded representation of the word “choice”, a student is able to know instantly having memorised the codes for the vowel sounds, consonant sounds and silent letters how to pronounce the word “choice” with certainty of its correct pronunciation. Thus in this example the letters “ch” are pronounced as in the word “chin”, the letters “oi” are pronounced as in the word “boy”, the letter “c” is pronounced as the letter “s” in “sun” and the letter “e” is not pronounced at all. It follows that by learning the 23 different vowel sounds, the 27 different consonant sounds and the code for different silent letters a student can look at a word coded in this format and determine the pronunciation with certainty.

It is to be noted that for the silent letters there are many combinations of letters which when occurring in words are not necessarily pronounced. Such as the letters “a” and “l” in the word “basically”. Therefore the list of silent letters is not fixed.

Because words are now able to be represented in a coded form which enables a teacher or student to pronounce the word with certainty, a teaching format is possible which potentially makes learning a language such as English much easier.

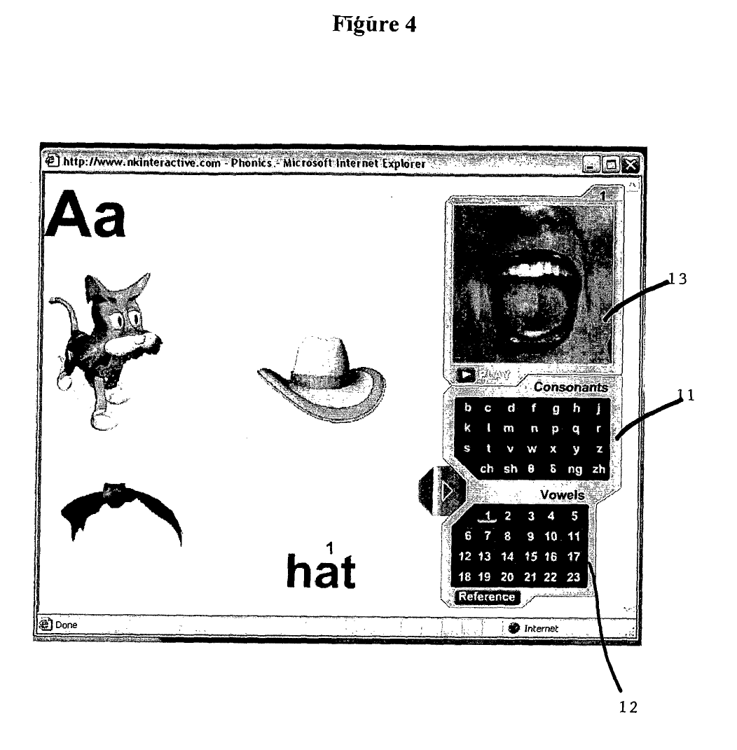

FIG. 4 shows a computer or video implementation of the coding format of the preferred embodiment in which the list of consonant sounds and vowel sounds are provided in separate boxes 11, 12. In the computer implementation by clicking a cursor located on one of the consonant or vowel sounds a display is provided of words incorporating these sounds. Thus for vowel 1 which is highlighted in FIG. 4, the word “hat” appears with the superscript 1 above the letter “a” in red. The letters “h” and “t” are both blue. A pictorial representation of a hat is displayed above the word and other things involving the same vowel sound such as a “cat” and a “bat” are shown to enable a student to practice the vowel sound represented by the numeral 1. Item 13 refers to a visual/audio feature of the preferred embodiment in which a model pronounces the sound to enable a student to view lip, tongue and facial movements to produce the sound.

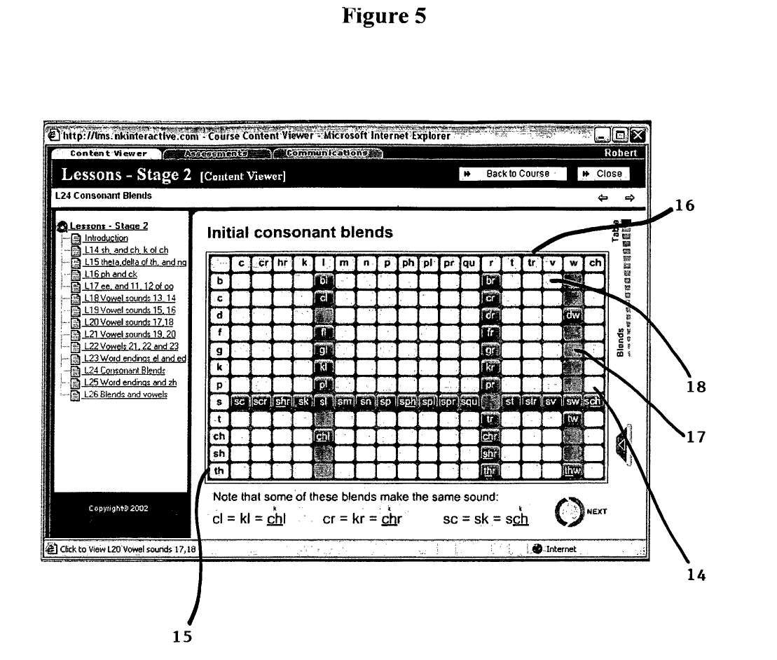

Another feature of the preferred embodiment is shown in FIG. 5. This figure shows a grid used to reproduce the initial consonant blend sounds in English. A voice file of a consonant blend is played by clicking on one of the darker blue buttons (dark grey in FIG. 5). The grid 14 shown in FIG. 5 consists of a vertical axis or column of initial consonant sounds 15 and a horizontal axis 16 of vowels which can be added to those in the column 15. A highlighted section 17 (dark grey) shows each grid square where it is possible to combine consonants in the column 15 with consonants in the row 16.

As an example the consonant “s” in column 15 when combined with consonant “l” in row 16 is represented as a darkened grid square “sl” on grid 14. If there is no English word which combines a consonant in column 15 with a consonant in row 16, then the grid appears as a blank square 18 for example. Thus the consonants “b” and “c” together represented as the first consonant in column 15 and row 16 respectively does not occur in an English word and therefore results in a blank square.

Because the grid incorporates the coding system outlined above a student will know how to pronounce a consonant blend by having previously memorised the coded sounds in accordance with the preferred embodiment.

As an example, the consonant sound “s” when combined with the consonant sound “hr” is represented by “sh” underlined, followed by “r”.

It is noted that a complete line is highlighted even if not all squares represent initial consonant blends. This allows a student to easily follow the lines of intersection between consonants in column 15 and in row 16.

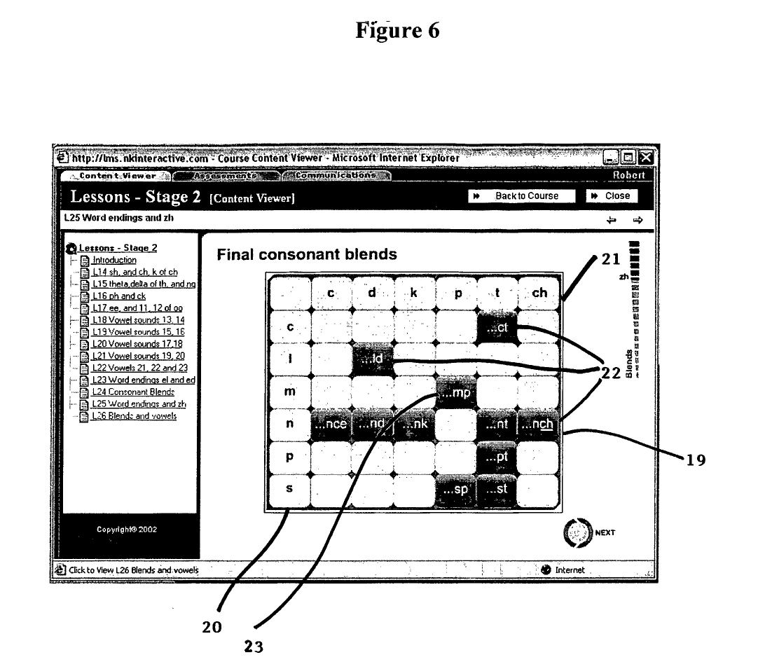

FIG. 6 shows a modification of the grid format for displaying blends of consonants so that it is more appropriate for final consonant blends. Thus, a rectangular grid 19 is shown as a display on a computer monitor, for example. Thus, a column of consonants —c l m n p s— represented by item 20 is shown with a row of consonants —c d k p t c h— represented by item 21.

The consonant blends which are allowable are highlighted in dark blue squares 22. Those which are not allowable remain as blank squares.

As an example the final consonant blend formed by combining consonants “m” and “p” results in the consonant blend “mp” represented by item 23.

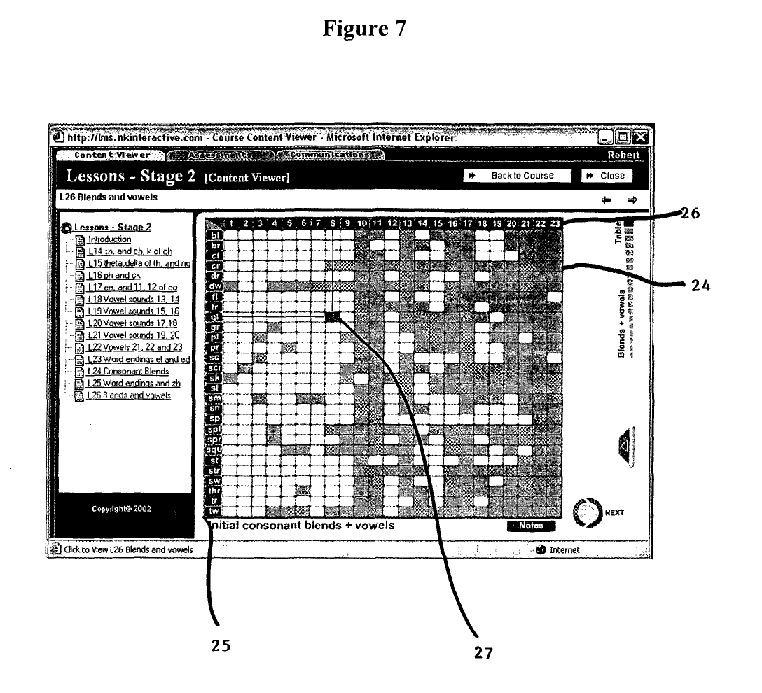

A further extension of the grid concept is shown in FIG. 7 where a grid 24 is displayed which provides a combination of the most commonly used consonant blends of English with the 23 different vowel sounds. The crosshairs on the screen locate a particular combination of consonant blend and vowel sound. As illustrated, the voice file would play consonant blend “gl” with vowel sound 8 to produce “gli” as in “glide”. Dark cells indicate that the combination of consonant blend and vowel sound is used in English. Empty (white) cells indicate that this combination of consonant blend and vowel sound is rarely used or not used at all in English.

In grid 24 the consonant sounds are shown along the vertical axis as item 25 and the vowel sounds along the horizontal axis as item 26.

The point of intersection of a consonant and vowel sound such as the “gl” and “8” as referred to above is highlighted by a darker coloured square. An illustration then can appear below showing a word with the blend and a voice and/or video representation can be provided to simulate the consonant/vowel blend.

FIG. 8 illustrates how the coding system outlined above can be used to provide a simple way of searching for different sound patterns.

Because each word may be encoded in an electronic form, it is possible to search for words having particular sounds. This includes combinations of sounds as well as combinations of sounds with other characteristics of words.

As an example a word will typically have the following features:

a number of letters, syllables, consonants, vowels, vowel sounds, consonant sounds, consonant diagraphs, consonant blends, silent letters, as well as different degrees of emphasis on letters in the words. The comprehensive nature of the coding system for each word enables a student to access different combinations of the above to practice word pronunciation and observe differences and similarities in pronunciation.

Each word in the dictionary is stored in a coded form with links to data relating to each word. Thus a request for a search as shown in FIG. 8 for the consonant “c” vowel sound 13 in combination with consonant sound “sh” vowel sound 13 and consonant “n” produces the list of words shown in FIG. 8. Each of these words includes the consonants, vowel sounds and consonant sounds requested in the search bar 30. Each of these words is shown in its coded form so that it can be easily pronounced. In addition letters or sounds which are emphasised are represented by a bolder font. Thus the word collection is shown in the second occurrence of “l” shown in a darker blue than the letter “c” at the beginning of letter. Likewise the second occurrence of the letter “c” is shown in a darker blue along with a bolder version of the letter “e” with the superscript ² above it. The vowels “o” are represented in a normal or darker font than the letter “e”. The letters “ti” and “n” are represented in the same font as the first letter “c”. This representation indicates that the “lec” in the middle of the word collection is emphasised more than the first and third syllables.

Each of the other words shown in FIG. 8 also have emphasis on the second syllable and are shown in darkened font. Thus in addition to the coding previously outlined, vowel sounds and consonant sounds can be represented in a different format such as by bolding colours or providing letters in different font to highlight an emphasis of a sound.

By using the coding system outlined above a search engine can interrogate a dictionary of thousands of colour and sound coded words for families of words with the same sound patterns. FIG. 8 shows the result of searching for three syllable words with the same beginning sounds and the same final sounds. The advantages of this searching system include the following:

i. the different ways the sound “sh” is spelled in these words;

ii. the position of the stressed syllable bold print;

iii. the frequent use of vowel sound 13 (schwa sound) in the unstressed syllables of longer words; and

iv. the rhythm and modulation of spoken English for this family of words as they are read out aloud.

Commands for interrogating the data base for the family of three syllable words begins with the hard sound of “c” then has “c” immediately followed by vowel sound 13.

According to one embodiment of the invention a system is provided incorporating a data processor, a scanner, a microphone, a mouse or similar cursor controller and software for electronically coding words into a phonetically coded text.

A system for implementing an automated teaching/learning aid incorporating the word coding system consists of a data processor such as a computer with inputs to a scanner, a keyboard, a camera, a microphone and a mouse or other cursor controlling device. The processor may incorporate or be connected to a data base and to a display unit such as a computer monitor.

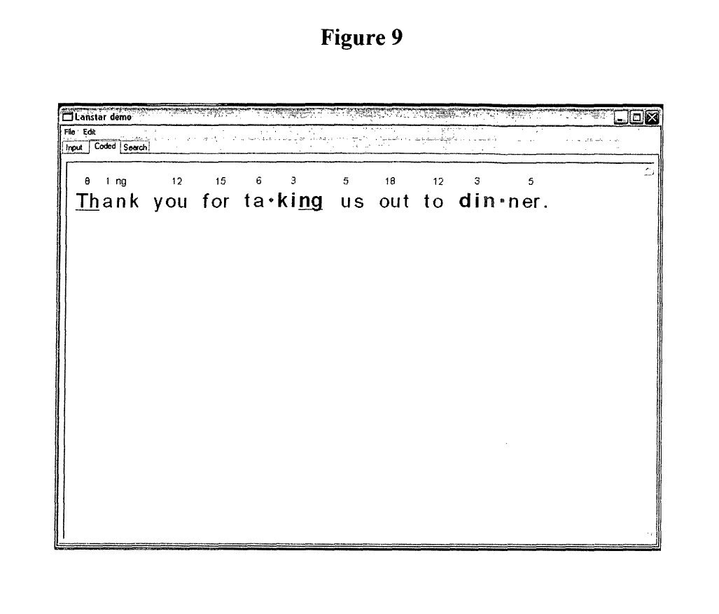

In accordance with the above system a student is able to type in a sentence using the keyboard and the sentence which for example may be “thank you for taking us out to dinner” is broken into individual words by the data processor which then accesses a library data base containing each of the words in phonetically coded form. The coded words are then displayed on the monitor in the coded form. This may be as shown in FIG. 9. When the sentence is typed in it is also possible to select a style of the English language such as Australian, UK or USA. The coded text is then produced as shown in FIG. 9. As shown each word is broken into its phonetically coded parts which include vowel sound codes, consonant sound codes and silent letter codes. It is also noted that dots are used to separate syllables of a word.

If the student does not desire to type in a sentence a scanner can be used to scan the sentence in or the word can be electronically transmitted from another location and even recorded by the microphone and camera. Furthermore voice recognition software can record a sentence and convert the sentence to the phonetically coded form shown in FIG. 9.

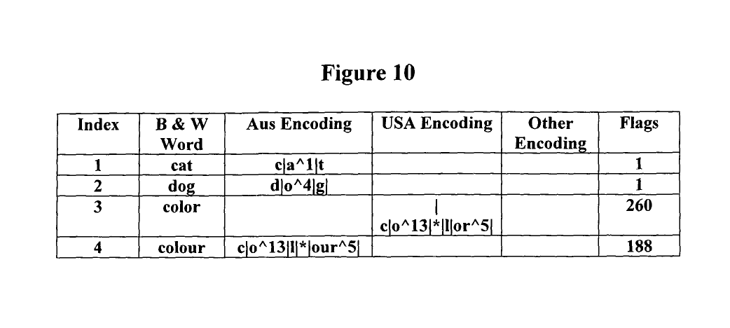

In accordance with the preferred embodiment words are stored in the library data base in a format similar to that shown in FIG. 10. The database table shown includes the following:

index: gives each word a unique index;

B and W word: gives a simple black and white representation of the word;

AUS encoding: encoded string of characters which details the phonetic encoding of the word for Australian accents;

USA encoding: as above only for mid-Atlantic accents from the USA;

Other encodings: this represents multiple columns, one per accent, like AUS and USA;

Flags: a bit mask holding information on special properties of certain words such as:

whether the word is a proper noun, whether the word appears in certain accents (e.g. “color” only appears in USA accents, “colour” appears in Australian and British Accents).

When a word is received for encoding, the accent button is selected and the computer program initiates a converter to convert from B and W to coloured. The converter breaks the passage into words. Words are separated by white and/or other non-alphabetical characters. Some words are coded in the dictionary with non-alphabetic characters including, e.g. “don't”. Because of this the converter needs to consult the library data base “dictionary” and do more than one pass over then input B and W text to decide how to break the input text into words.

As the pronunciation of some words charges depending on position relative to other words “e.g. when the word “the” immediately precedes a word starting with a vowel, it has a long 7 “e”. When the word “the” immediately precedes a word starting with a vowel, it has a short 13 “e”. The converter is able to identify which type of “e” vowel sound is applicable and produce a word with the appropriate vowel sound code.

The encoding process may also use information in a flags column to alter the coloured output for a coded word in a variety of ways.

An example of the encoding process is provided as follows:

For the example: head phone, the word is split into vowels and consonants. Each sound is appended with a pipe

h|ea|d|ph|o|n|e

Any syllables are inserted as asterisk characters with trailing pipes.

h|ea|d|*|ph|o|n|e|

Superscripts and colouring are added by adding a caret followed by a code.

h|eaˆ2|d|*|phˆf|oˆ9|n|eˆ0 |

Stress is added by adding square brackets around a section of the word.

[h|ea\hat{2}|d|]*|phˆf|oˆ9|n|eˆ0|

Consonant diagraphs are notated by adding curly braces around their component characters.

[h|eaˆ2|d|]*|{phˆf|}oˆ9|n|eˆ0|

This is the format used by the dictionary editors. The way it is stored on disk in memory as a machine readable format will change to avoid the use of printing characters.

The searching process as outlined previously involves looking for matches of items entered into the search window in the library database.

Although it is preferred that the above embodiment of the invention is implemented using computer software it is also possible to provide a converter in the form of electronic hardware with embedded programming which allows conversion of words to the phonetically coded format.

1. A method of encoding words for language teaching comprising the steps of identifying a plurality of different vowel sounds, representing each different vowel sound and the letters forming the vowel sound by a first indicia and a second indicia, storing the different first and second indicias for each vowel sound, identifying a plurality of different consonant sounds, representing each consonant sound by a third indicia and a selection of consonant sounds by a fourth indicia, storing the third and fourth indicia for each consonant sound, identifying a plurality of different silent letters occurring in words, representing each silent letter by a fifth indicia and storing the fifth indicias for each silent letter whereby a word is represented by a combination of the first to fifth indicia.

2. The method as claimed in claim 1, wherein the selection of consonant sounds comprises consonant diagraphs.

3. The method as claimed in claim 1, wherein the first indicia comprises a number.

4. The method as claimed in claim 1, wherein the second indicia comprises a color.

5. The method as claimed in claim 4, wherein the second indicia comprises a single color.

6. The method as claimed in claim 1, wherein the third indicia comprises a color.

7. The method as claimed in claim 6, wherein the third indicia comprises a single color.

8. The method as claimed in claim 1, wherein the fourth indicia comprises an underscore located underneath consonant diagraphs.

9. The method as claimed in claim 1, wherein the fourth indicia comprises a symbol.

10. The method as claimed in claim 1, wherein the fifth indicia comprises a single color.

11. The method as claimed in claim 1, wherein a word is represented by a combination of letters and indicia.

12. The method as claimed in claim 11, wherein the letters are represented by a color indicative of the second, fourth or fifth indicia by which they are represented.

13. The method as claimed in claim 1, including the step of representing a group of consonant sounds by a sixth indicia and storing the sixth indicia for each consonant sound represented.

14. The method as claimed in claim 13, wherein the sixth indicia comprises a notation indicative of the pronunciation of the consonant sound.

15. A system for teaching a language comprising a database which stores a plurality of different vowel sounds, with each vowel sound and its composing letters represented by a first indicia and a second indicia, a plurality of different consonant sounds, with each consonant sound represented by a third indicia and a selection of consonant sounds by a fourth indicia, a plurality of different silent letters occurring in words, with each silent letter represented by a fifth indicia, and a plurality of different words, a conversion means which converts each word into a converted form comprising the indicia and a display means which displays a word in converted form, and wherein the conversion means is adapted to convert a word input into the system and utilize the display means to display the word in converted form.

16. A method of displaying words for language teaching, comprising the steps of identifying a word, encoding the word into a plurality of indicia components and displaying the encoded word comprising indicia components, wherein the plurality of indicia comprise a first and second indicia representing different vowel sounds and their composing letters, third indicia representing different consonant sounds, fourth indicia representing a selection of consonant sounds and fifth indicia representing different silent letters occurring in words.

17. The method as claimed in claim 1, including the step of displaying a matrix with sounds of one type along one axis and sounds of another type along another.

18. The method as claimed in claim 17, including displaying a composite of sounds from each axis by a zone corresponding to a point of intersection of the sounds on the grid.

19. The method as claimed in claim 1, including the step of searching for words including at least one of the indicia, vowel sounds, consonants, consonant diagraphs, silent letters.

20. The method as claimed in claim 16, including the step of displaying a matrix with sounds of one type along one axis and sounds of another type along another.

21. The method as claimed in claim 16, including the step of searching for words including at least one of the indicia, vowel sounds, consonants, consonant diagraphs, silent letters.
